(19) United States
(12) Patent Application Publication
(10) Pub. No.: US 2007/0043837 A1
(43) Pub. Date: Feb. 22, 2007

(54) Method and system for producing web pages matched to client properties

(75) Inventors: Eckhard Kruse, Heidelberg (DE); Yauheni Veryha, Mannheim (DE)

Correspondence Address: BUCHANAN, INGERSOLL & ROONEY PC, POST OFFICE BOX 1404, ALEXANDRIA, VA, 22313-1404, US

(73) Assignee: ABB RESEARCH LTD, Zurich (CH)

(21) Appl. No.: 10/552,479

(22) PCT Filed: Apr. 7, 2004
(86) PCT No.: PCT/EP04/03721

§ 371 Date: Sep. 1, 2006

(51) Int. Cl. G06F 15/177

(52) U.S. Cl. 709/220

(57) ABSTRACT

The invention relates to a method and a system for automatically producing web pages (5), (6), (7) for client appliances (1), (2), (3) of different client type (A), (B), (C) and with different client properties, where the client appliances (1), (2), (3) communicate with a web server (4) using client requests (14), (16), (18) and server responses (15), (17), (19), and the web server (4) stores web pages (5), (6), (7). The web server (4) is used to store web components (24), (37), (38), (39), (40), (41), (42), (43), (44), (45), and the client requests (14), (16), (18) sent to the web server (4) are used to identify the client type (A), (B), (C) and the client properties of the client appliance (1), (2), (3). From these, a respective profile is read in or produced for the respective client appliances (1), (2), (3), and the properties of the client appliances (1), (2), (3) are ascertained from the profile.

The web components (24), (37), (38), (39), (40), (41), (42), (43), (44), (45) are instantiated on the basis of the properties of the client appliances (1), (2), (3). The instantiated web components (24), (37), (38), (39), (40), (41), (42), (43), (44), (45) are used to produce representations of the requested web pages (5), (6), (7) and these are sent to the client.

The invention relates to a method and a system for producing web pages for client appliances, where the web pages are automatically matched to the type and properties of the client appliances.

The large number of different client appliances currently used for communication via the Internet, which include PCs, laptops, handheld computers or mobile telephones with WAP capability, for example, require a multiplicity of different web browsers for accessing the Internet. The various client appliances or appliance types have different technical features. By way of example, their display devices are in the form of black-and-white or color screens of different size and resolution, or their input devices are in the form of a keypad or touchscreen. However, even appliances with identical properties can use different web browsers, for example Internet Explorer, Netscape or Opera, whose support for special functions going beyond the standard language HTML 3.2, in particular, differs greatly in some cases.

When providing web pages from the Internet, the web server is not able to make fixed assumptions about the properties of the client appliance to which it is transmitting the web pages. Since different web browsers may be used, it is found to be difficult to provide pages having a high level of user convenience and interactive contents instead of simple HTML pages, which are usually created in standard form for all browsers, since this requires the use of special complex client-end technologies, such as dynamic HTML (Hypertext Markup Language), Frames, Cookies, JavaApplets or ActiveX Controls, which are not supported by many browsers, or are supported in different ways in different browsers. This may result in web pages being displayed incorrectly in some browsers, or not being able to be displayed at all.

With the future continuing increase in the spread of mobile terminals with Internet access, particularly WAP mobile phones, UMTS mobile phones, handheld computers or pocket PCs, the web contents of the web pages need to be conditioned in appropriate form not only for different browsers but also for much smaller displays, for example.

At present, support for the diversity of different client appliances is normally achieved only by virtue of an individual, sometimes very complex version of the web pages being created for each client type.

One approach to a solution in previous web technologies is to develop different web pages or different web programs, such as Active Server Pages, which is described in Williams, A., Barber, K., and P., Newkirk, “Active Server Pages Black Book”, 10^{th} ed., Coriolis Group, 1998, pp. 600, or Java Server Pages, which is described in Hall, M., “Core Servlets and JavaServer. Pages”, Prentice Hall PTR, 2000, pp. 608, in order to handle the graphical user interface and interaction with each specific client environment on an individual basis.

However, this requires the code for each web page to be created in multiple form modified as appropriate for the respective client appliance. This inevitably results in the complexity for creating and maintaining the web pages being multiplied, since the web contents need to be created or modified in all manifestations of the pages.

A further drawback of previous web technologies for producing web pages which are matched to the properties of the different client appliances results from the fact that various Internet addresses, known as “URLs” (Uniform Resource Locators), need to be provided for the web pages tailored to different client types.

The invention is therefore based on the object of specifying a method and a system for producing web pages for client appliances, where the web pages are automatically matched to the type and properties of the client appliances in order to produce an efficient representation and minimal complexity for maintenance of the web pages.

This object is achieved by a method for automatically producing web pages for client appliances of different client type and/or with different client properties having the features specified in claim 1.

Advantageous refinements and a system for producing web pages for client appliances of different client type and with different client properties are specified in further claims.

A basis for automatic production of a web page requested by the client appliances is the web pages on a web server, which comprise one or more recorded web components in various variants for the different client appliances and browsers and which produce a matched representation of the requested web page for the respective client appliance.

In this context, a web component is an object which stores both the server-end code and data for the web page and which makes a specific set of services available to the web server in order to condition contents for the web pages in suitable fashion.

When the web server receives a page request from a client appliance, which is subsequently also called client, it ascertains the type and properties of the client, particularly of the browser, and instantiates the web components for the requested web page which are suitable for representing the page content for this client. The instantiated server-end web components then produce the page content in suitable fashion for the client which has requested the page.

Alternatively, it is also possible to instantiate fundamentally all web components of a web page, but with even then only the web components which are needed for the respective client being used to produce the page contents.

In this case, the properties of the client comprise the service features of the browser, such as support for DHTML (Dynamic Hypertext Markup Language), for Cookies or for frames, but also the properties of the display, such as PC screens, handheld computers or WAP mobile phones. Determining what kind of client type and browser are involved is in this case preferably done on the basis of the information in the corresponding text fields in the http request header (file header of a hypertext transfer protocol request).

Once the instantiated web components have produced the content of the web page for the client, the web server transmits the web page which has been matched to the client type and to the client properties in this way to the client.

In this case, it is sufficient for the web server to determine just once for a client making a request for a web page what kind of client is involved. After that, an individual session is produced for this client on the web server (for example in accordance with the procedure described in Williams, A., Barber, K., and P., Newkirk, “Active Server Pages Black Book”, 10^{th} ed., Coriolis Group, 1998, pp. 600). This session can then be used to store the profile of the client.

If the client now makes further requests to the web server, the client's profile which has been stored and available on the web server all this time is used to produce the web page. If the client effects no further access to the web server over a relatively long time, the session in question is ended.

In an alternative embodiment, the client profile is stored on the client, for example in the URL or in the form of Cookies in the web page.

The invention advantageously provides efficient support for a multiplicity of different client appliances with different browsers.

Each web application which is intended to support more than one client appliance or one browser type benefits from the described use of the web components.

The invention advantageously allows the complexity for developing and maintaining the pages to be minimized.

It is also possible to tailor the web contents of the requested web pages to the various client appliances in optimized fashion, with the complexity for developing and maintaining the web contents of the pages which are shown on the various client appliances in different ways being minimized.

The inventive method may also be used advantageously for the multiplicity of the mobile terminals with Internet access which are being used to an ever greater extent by virtue of the web contents of the web pages also being conditioned in appropriate fashion for much smaller displays.

Similarly, the web contents can be provided at just one URL which is identical for various client appliances. In this case, it is also not necessary to divert the requests from the client appliances to other, client-dependent URLs.

Exemplary embodiments which are shown in the figures of the drawing below are intended to give a more detailed explanation and description of the invention and also of advantageous refinements and improvements of the invention.

### IN THE DRAWING

FIG. 1 shows Internet access to a web page by various clients with Internet capability,

FIG. 2 shows an inventive system configuration for the client-dependent production, conditioning and representation of web pages,

FIG. 3 shows a method sequence comprising a client request and automatic setup of a web page,

FIG. 4 shows a design for a web page on a web server, and

FIG. 5 shows an exemplary embodiment for producing a web page.

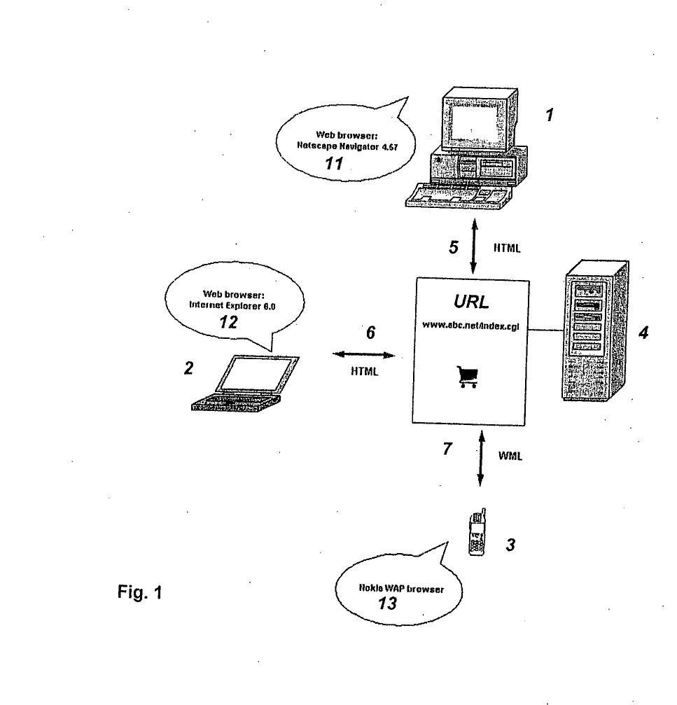

FIG. 1 shows Internet access by various client appliances with Internet capability, such as a PC/workstation 1, a laptop 2 or a WAP mobile phone 3, to a web server 4.

On the Internet or intranet, the various client appliances 1, 2, 3 of different type are used and differ, by way of example, in terms of the properties of their screens, their input options or their Internet browsers 11, 12, 13.

The various client appliances 1, 2, 3 communicate with the web server 4, on which web pages are stored, by requesting web contents from a standard Internet address (URL) for an Internet service which is identical for all clients, for example http://www.abc.net/index.cgi.

The web server 4 identifies the respective type or the properties of the client 1, 2, 3 and transmits a suitably produced web page 5, 6 in possibly different HTML (Hypertext Markup Language) formats to the PC/workstation 1 and the laptop 2 or transmits a page 7 in WML (Wireless Markup Language) format to the mobile phone 3 with WAP capability. In this way, all client appliances 1, 2, 3 receive the web content from the same URL, but in accordance with their specific properties.

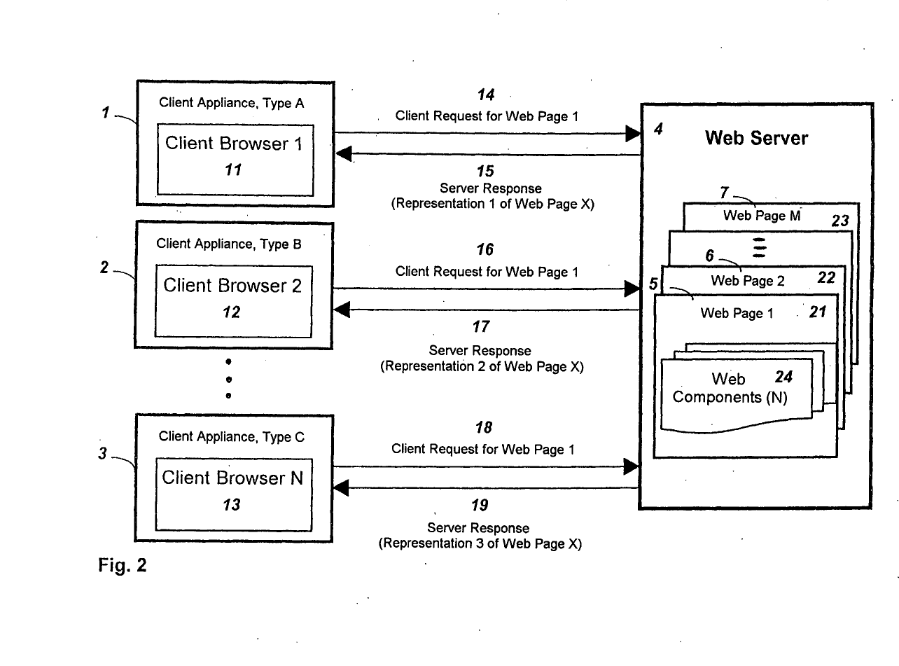

FIG. 2 shows an inventive system configuration for client-dependent production, conditioning and representation of web pages 5, 6, 7 using web components.

The various client appliances 1, 2, 3 communicate with the web server 4, on which the web pages 5, 6, 7 are stored, using client requests 14, 16, 18 and server responses 15, 17, 19.

Each of the web pages 5, 6, 7 contains one or more web components 24 for conditioning information for the various client types A, B, C of the client appliances 1, 2, 3. Depending on the type A, B, C of the respective client 1, 2, 3, the properties of the client differ, for example in terms of the screen, the input options such as keypad and mouse, or in terms of the web browser 11, 12, 13, whose browser capabilities support a subset of the existing web technologies, for example DHTML, HTML with various document object models or various data formats such as HTML or WML.

The client appliances 1, 2, 3 send the client requests 14, 16, 18 for a first web page 5 to the web server 4. The web server 4 evaluates the client requests 14, 16, 18 by first ascertaining the type A, B, C of the client 1, 2, 3 and the browser type 11, 12, 13 with the associated browser capabilities. Next, the web server 4 instantiates the web components 24 suitable for the respective client appliance 1, 2, 3 in the first page 5, which produces the page contents for the first page 5 in line with type A, B, C and with the properties of the corresponding client 1, 2, 3.

Next, the web server 4 returns the first page 5 produced by the selected web components 24 to the corresponding client 1, 2, 3 as server response 15, 17, 19. In this way, each client 1, 2, 3 receives an adapted representation of the first page 5, which is read, processed or displayed in optimum fashion. If further web pages 5, 6, 7 are requested by the client appliances 1, 2, 3, the method sequence described is repeated.

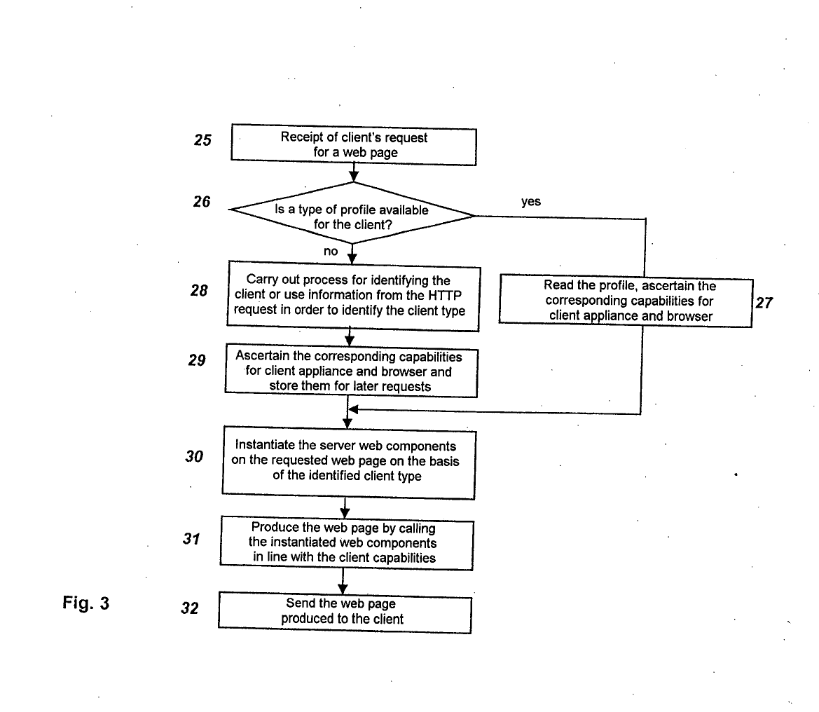

FIG. 3 shows a method sequence on the basis of the method steps 25-32, where a page 5, 6, 7 requested by a client 1, 2, 3 is automatically produced and returned to the client 1, 2, 3.

In a first step 25, a client request 14, 16, 18 is transmitted to the web server 4. In the HTTP request header, the request 14, 16, 18 contains the URL of the called page and also further information about the client 1, 2, 3.

A second step 26 is used to check whether the client 1, 2, 3 has already sent a request 14, 16, 18 to the web server 4 beforehand and a profile is available for the client 1, 2, 3. If a request 14, 17, 18 has already been made, then there is already a profile with the properties of the client 1, 2, 3, said profile merely being read in a third step 27.

If, by contrast, there is not yet a profile available for the client 1, 2, 3, then the web server 4 automatically creates a new profile for the client 1, 2, 3 in a fourth step 28, and the properties of the client 1, 2, 3 are entered into this new profile in an identification process. In this case, the information about the client properties, such as browser type and browser capabilities of the client 1, 2, 3, from the HTTP request header are used in order to identify the client type A, B, C.

If it is not possible to create the profile automatically, for example because the client properties are intended to be configured further in great detail, then in a further embodiment the client 1, 2, 3 is identified using a special dialogue. In this context, the web server 4 first transmits an interposed configuration page to the client 1, 2, 3. The user uses this page to set the specific handling of his client 1, 2, 3, for example by selecting from a list of different client types A, B, C.

Once the client 1, 2, 3 has now been identified, the web server 4 ascertains a profile for the client appliances 1, 2, 3 and their browsers 11, 12, 13 on the basis of the client properties and capabilities in a fifth step 29. The profile is stored on the web server for later page requests by the client 1, 2, 3.

If it is not possible to identify the client 1, 2, 3 or its type A, B, C and its properties, then a further embodiment has provision for an appropriate error page to be returned to the client 1, 2, 3 or for a standard profile, for example as a simple HTML client, to be used for the client.

In a sixth step 30, the web server 4 instantiates the server-end web components 24 for the requested web page 5, 6, 7 on the basis of the previously ascertained client profile.

In a further step 31, the web page 5, 6, 7 is then produced in line with the client type A, B, C and the client properties by calling the instantiated web components 24.

In a final step 32, the web server 4 transmits the requested web page 5, 6, 7 conditioned in optimum fashion for the client 1, 2, 3 by the previous steps to the appropriate client appliance 1, 2, 3.

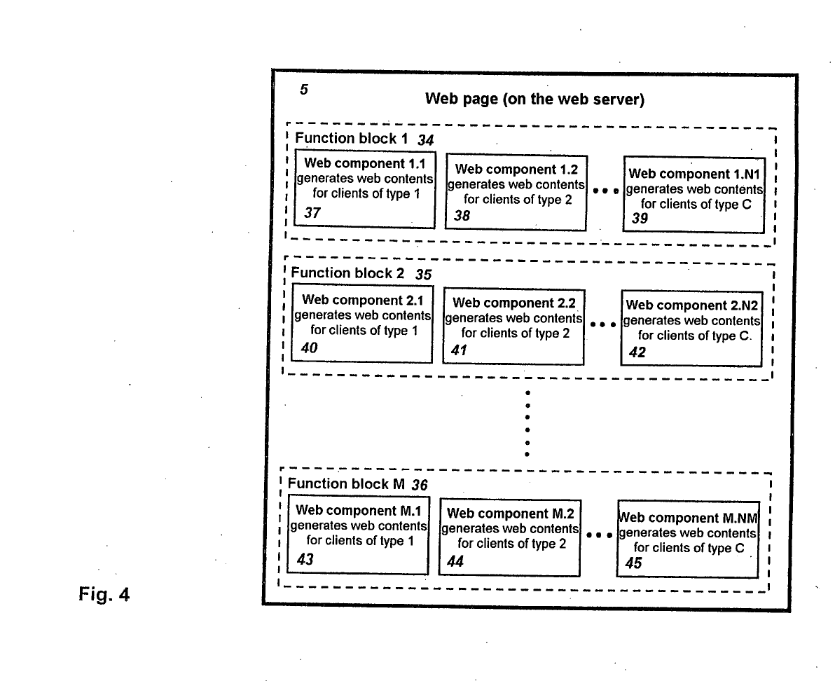

FIG. 4 shows the design of a web page with its server-end Internet components on a web server.

The web page 5 is divided into a plurality of function blocks 34, 35, 36, the function blocks 34, 35, 36 being menus, static contents or form blocks, for example. Each of the function blocks 34, 35, 36 has one or more web components 37-45 which represent the content of the function block in question in a manner which is suitable for the respective client 1, 2, 3.

Components which belong to the same function block produce web page contents which perform the functions or tasks of the function block in question as well as possible by representing the portion of the page in a manner which is optimum for the respective client type A, B, C.

By way of example, the first function block 35 contains a first web component 37 which generates the web contents of a first web page 5 for clients of type A, a second web component 38 which generates the web contents for clients of type B and a third web component 39 which generates the web contents for clients of type C.

By way of example, the second function block 36 contains a fourth web component 40 which generates the web contents of a second web page 6 for clients of type A, a second web component 41 which generates the web contents for clients of type B and a third web component 42 which generates the web contents for clients of type C.

The web components 37 to 45 which are responsible for a client type A, B, C and are associated with the various function blocks 34, 35, 36 thus together take care of the design of the full web page 5, 6, 7. The resultant, possibly large number of web components 24, 37 to 45 within a web page can be arranged in accordance with ordinary web page structure models.

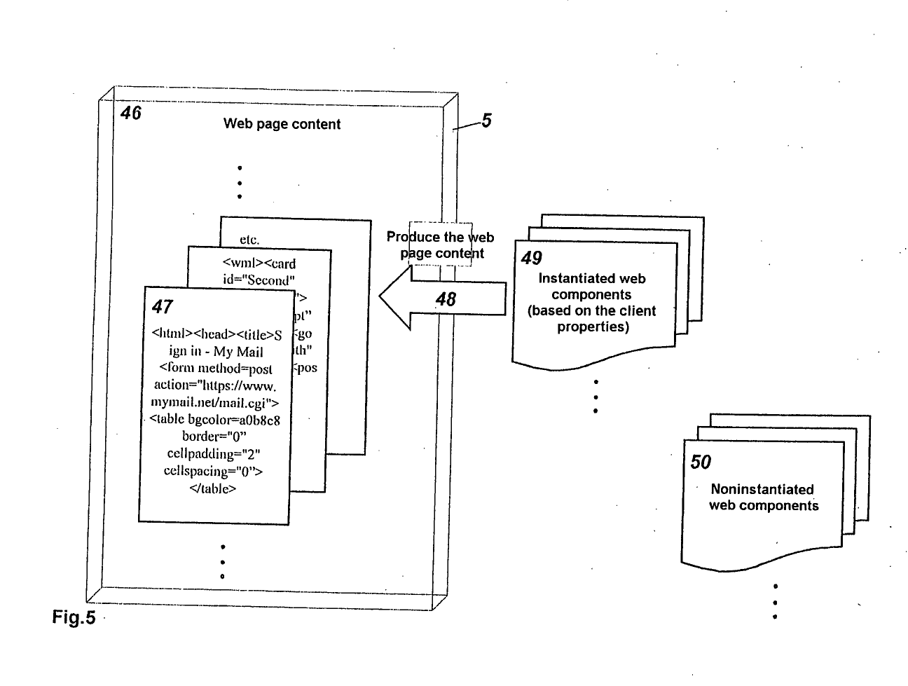

FIG. 5 shows an exemplary embodiment for producing a web page 5 and the structure of a web page content 46 of the web page 5 using the instantiated web components 49.

The instantiated web components 49 produce the respective content 47 of the web page 5. The production of the web page content 48 is based on the client properties of the instantiated web components 49.

The noninstantiated web components 50 are not involved in page production 48 and therefore require no resources on the web server at this time.

1. A method for automatically producing web pages for client appliances of different client type and/or with different client properties, where the client appliances communicate with a web server using client requests and server responses and the web server stores web pages, wherein
the web server stores web components,
the client requests sent to the web server are used to identify the client type and the client properties of the client appliance,
the web components are instantiated on the basis of the properties of the client appliances,
instantiated web components are used to produce representations of the requested web pages and to transmit them to the client.

2. The method as claimed in claim 1, wherein the representations of the web pages which are reduced by the web components are read, processed or displayed by the client appliances.

3. The method as claimed in 1, wherein from the identified client properties of the respective client appliance the web server reads in or produces a profile and the profile is used to ascertain the properties of the client appliances.

4. The method as claimed in claim 1, that wherein the web components are used to store server-end code and data for the web pages.

5. The method as claimed in claim 1, wherein the properties of the client appliances include browser type and browser capabilities, properties of the displays and of the input devices of the client appliances.

6. The method as claimed in claim 1, wherein the type ascertained in the web server and the ascertained properties of the client appliances are used to produce an individual session for the respective client appliance, said session being used to store a profile for the respective client appliance.

7. The method as claimed in claim 6, wherein the stored profiles of the client appliances are used for further client requests to the web server until the session on the web server is ended.

8. The method as claimed in claim 1, wherein the profiles of the client appliances are stored in the URL or in the form of cookies in the web page.

9. The method as claimed in claim 1, wherein information about the properties and about the type of the respective client appliance is entered into the profiles which the web server automatically creates for the client appliances from the file header of an HTTP request in an identification process.

10. The method as claimed in claim 1, wherein the client appliances are identified using a special dialogue, with the web server transmitting a configuration page to the client appliance, and the user of the client appliance making a selection from a list of different client types.

11. The method as claimed in claim 1, wherein the web server returns an error page to the client appliance or uses a standard profile for the client appliance if the web server is not able to identify the client appliance.

12. A system for automatically producing web pages for client appliances of different client type and/or with different client properties, where the client appliances communicate with a web server using client requests and server responses and the web server stores web pages wherein the web pages comprise web components for automatically producing representations of the web pages for different client types and different client properties of the client appliances.

13. The system as claimed in claim 12, wherein the web server uses the client requests to produce the client type and the client properties using the web component associated with the respective client appliances the page content of the web pages creates.

14. The system as claimed in claim 12 wherein the client properties of the respective client are browser type and browser capabilities, properties of the displays and of the input devices of the client appliances.

15. The system as claimed in claim 12, wherein the web server returns the representation of the web pages which is produced by the web components to the respective client appliance using the server responses.

16. The method as claimed in 2, wherein from the identified client properties of the respective client appliance the web server reads in or produces a profile and the profile is used to ascertain the properties of the client appliances.

17. The system as claimed in claim 13, wherein the client properties of the respective client are browser type and browser capabilities, properties of the displays and of the input devices of the client appliances

18. The system as claimed in claim 13, wherein the web server returns the representation of the web pages which (representation) is produced by the web components to the respective client appliance using the server responses.

19. The system as claimed in claim 14, wherein the web server returns the representation of the web pages which is produced by the web components to the respective client appliance using the server responses.
